(19) United States
(12) Patent Application Publication
(10) Pub. No.: US 2010/0272992 A1
(43) Pub. Date: Oct. 28, 2010

(54) METHOD FOR COATING A MOLDED FIBER CEMENT ARTICLE OR MOLDED CONCRETE ARTICLE

(75) Inventors: Lars Koppelmann, Mannheim (DE); Roland Streng, Frankisch-Crumbach (DE); Joachim Strauch, Haltern (DE); Markus Salzmann, Lautersheim (DE); Peter Kitzel, Ludwigshafen (DE)

Correspondence Address: CONNOLLY BOVE LODGE & HUTZ, LLP, P O BOX 2207, WILMINGTON, DE, 19899, US

(73) Assignee: BASF SE, Ludswigshafen (DE)

(21) Appl. No.: 12/809,680

(22) PCT Filed: Dec. 19, 2008
(86) PCT No.: PCT/EP08/67961

§ 371 Date: Jun. 21, 2010

(30) Foreign Application Priority Data
Dec. 19, 2007 (EP) 07123661.6

(51) Int. Cl. B32B 13/00; B32B 37/04

(52) U.S. Cl. 428/357; 156/84

(57) ABSTRACT

The invention relates to a method of coating a fiber-cement or concrete molding with a polymeric film, which comprises
a) placing and securing the molding in a capsule, the polymeric film being mounted between capsule wall and molding,
b) evacuating the air in the chamber between polymeric film and molding,
c) heating the polymeric film,
d) letting down a second chamber between polymeric film and capsule wall to atmospheric pressure with external air, and
e) thereby pressing the polymeric film onto the molding, and maintaining a vacuum during this pressing operation;
   and also to fiber-cement and concrete moldings coated using this method.

The invention relates to a method of coating a fiber-cement or concrete molding with a polymeric film, which comprises
a) placing and securing the molding in a capsule, the polymeric film being mounted between capsule wall and molding,
b) evacuating the air in the chamber between polymeric film and molding,
c) heating the polymeric film,
d) letting down a second chamber between polymeric film and capsule wall to atmospheric pressure with external air, and
e) thereby pressing the polymeric film onto the molding, and maintaining a vacuum during this pressing operation.

Fiber-cement slabs and moldings can be coated with a polymeric film using membrane presses. Flat elements (panels/slabs) can be laminated/coated with film in conventional continuous methods. There are no fiber-cement slabs available on the market that are coated with polymeric film. Where a coating is desired on more than one side, it would be necessary to employ more than once the methods described in the literature. Complete cladding of the fiber-cement slab or molding is difficult to accomplish with the methods known from the literature.

Concrete moldings have not to date been covered with polymeric films. For concrete moldings which have a structural surface, more particularly, there are no coating techniques available.

Moldings comprising ceramic, fired materials, especially here roof decks and components used outdoors, acquire their color from stoving enamels or through the natural color inherent in the material as a consequence of the firing process.

Shape, color and surface of fiber-cement or concrete moldings are difficult if not impossible to alter subsequently. In order to give these moldings a particular color or surface it has to date been necessary to paint or impregnate these moldings. Specifically, appearance and properties such as tactility and weathering stability of the fiber-cement or concrete moldings, for example, often leave something to be desired.

It was an object of the present invention, therefore, to find a method that allows for easy and subsequent surface design of the fiber-cement or concrete moldings.

Surprisingly it has now been found that the method stated at the outset is outstandingly suitable for implementing subsequent surface design in the case of fiber-cement or concrete moldings.

A comparable method of coating doors is already known from WO 01/032400. WO 01/032400, however, does not indicate whether and, if so, in what manner shaped fiber-cement or concrete elements can be coated using that method.

The method described in WO 01/032400 is expressly incorporated by reference here. Explicit reference is made more particularly to the following method features and apparatus features of WO 01/032400, which are used individually or, preferably, in combination:
infrared heating, which heats the polymeric film—preferably beyond the softening point—prior to pressure-application. This prevents blistering, tearing of the film or stress-whitening of the film at the edges;
separate chambers between fiber-cement or concrete molding and film (chamber A), and between film and capsule wall (chamber B). Advantageously the chambers A and B are subjected to a vacuum simultaneously or, preferably, in succession. This prevents creasing of the film, or premature contact of the film with the fiber-cement or concrete molding. Letting down the vacuum in chamber B to atmospheric pressure presses the film onto the fiber-cement or concrete molding, while in chamber A the vacuum is still maintained;
simultaneous coating of the fiber-cement or concrete molding with film on opposite sides—this can be achieved, for example, by anchoring the fiber-cement or concrete molding in a frame made of wood, metal or plastic and holding it centered in the middle of the coating chamber by means of a holder at the top ends of the frame. Beneath the fiber-cement or concrete molding a further film is introduced, thus forming a third chamber, C, between this film and the lower capsule wall. All three chambers are then subjected to a vacuum, as already described early on above, and, after the film has been heated, the fiber-cement or concrete molding is coated correspondingly on both sides by opening of the chambers A and C;
coating of the polymeric film or, preferably, of the fiber-cement or concrete molding with an adhesive, which permits long-lasting adhesion of the film to the fiber-cement or concrete molding.

The adhesive may be based either on the basis of an aqueous, VOC-free PU base, or on a sprayable (PU) hotmelt which is applied with a special application gun.

The method of the invention for the double-sided coating of a fiber-cement or concrete molding with a polymeric film comprises
a) placing and securing the molding in a capsule between films, in a spaced relationship,
b) evacuating the air from the capsule, and
c) thereby pressing the films onto opposite faces of the molding, during which a vacuum is maintained between the films.

The method of the invention is suitable, surprisingly, for the two-sided or multisided coating of fiber-cement or concrete moldings, which were hitherto amenable to coating with polymeric film only in a plurality of steps.

By fiber-cement slabs, more particularly, mineral fiber slabs. Large-format fiber-cement panels for ventilated curtain facades are very well established in practice. They are composed of a noncombustible, highly compressed material comprising fiber-reinforced cement paste, which in the hardened state is stable dimensionally and to weathering. The greatest fraction of raw material is formed by the Portland cement binder, which is produced by firing limestone and clay marl. To optimize the properties of the product it is admixed with additional substances such as finely ground limestone and ground fiber cement (recycled), for example. Reinforcing fibers used are synthetic organic fibers of polyvinyl alcohol. These are fibers which are used in a similar form in the textiles sector for outerwear and protective fabrics, for nonwovens, and for sutures. The most important factor is their physiological harmlessness. During the production of fiber cement, process fibers are used as filter fibers. These are primarily cellulose fibers, of the kind also used in the paper industry. Air is also present in the form of microscopic pores. This micropore system gives rise to a frost-resistant, moisture-regulating, breathable, and yet watertight building material. (Planning and application Eternit AG).

Fiber cement is a composite material made of cement and high-tensile fibers, also known under the trade name Eternit (from the latin aeternum=everlasting, constant). Fiber cement comprehends clay, fired clay, and ceramic. The coating of the invention allows these materials to be made watertight.

The production is widespread of roof shingles, corrugated roofing slabs, façade linings, drinking-water and wastewater pipes, plant pots, and articles for open spaces. Flooring elements made of fiber-cement are used for humid rooms such as bathrooms and kitchens, an example being Perlcon-Floor from Perlite/Knauf, 2 cm thick with step fold.

The principal fiber used earlier was asbestos. However, in the course of processing and the decomposition of aging materials, the asbestos fibers, which are injurious to health, can be released. Asbestos cement materials must be manually uninstalled (without destruction). Asbestos has now been replaced, however, by other fibers, examples being glass, CRP or cellulose fibers. Here it is possible to make use, for example, of products from the companies Eternit AG Deutschland or Karl Bachl GmbH & CO KG.

Concrete is to be understood in the sense of the invention as

Adhesives used are preferably aqueous, polyurethane-based systems, including both one-component and two-component systems. Suitable one-component adhesives include PU dispersions, an example of which is in this case Jowapur® 150.50. Suitable two-component adhesives include combinations of PU dispersions such as Jowapur® 150.30, for example, with isocyanates such as Jowat® 195.40, for example. In general, however, acrylate-based or epoxy resin-based adhesives are also suitable for use.

The adhesive can be applied by the conventional techniques such as spreading, rolling or spraying, with spraying being particularly preferred. A 20-minute drying time at room temperature following the application of the adhesive is sufficient in the case of the systems described.

Use may also be made of hotmelt adhesives which are rollered on, knife-coated, rolled, and sprayed. It is preferred to use polyurethane adhesives which crosslink with moisture.

Suitable polymeric films are more particularly polyvinyl chloride, styrene copolymers, polypropylene, polyvinylidene fluoride, thermoplastic polyurethane (TPU), and polymethyl methacrylate (PMMA). On account of their weather resistance, polyvinyl chloride and styrene copolymers such as SAN, AMSAN, and, more particularly, ASA have proven more particularly suitable for exterior applications. In the case, for example, of the ASA copolymer, the film can be modified by 0.5%-30% by weight of a thermoplastic elastomer. Typical classes of thermoplastic elastomer that can be used are as follows: TPE-O (olefin-based thermoplastic elastomers, predominantly PP/EPDM), TPE-V (crosslinked, olefin-based thermoplastic elastomers, predominantly PP/EPDM), TPE-U (urethane-based thermoplastic elastomers), TPE-E (thermoplastic copolyesters), TPE-S (styrene block copolymers, such as SBS, SEBS, SEPS, SEEPS, MBS, for example), and TPE-A (thermoplastic copolyamides, e.g., PEBA). Particular preference is given to using SAN, AMSAN, ASA, TPU or PMMA films. More particular preference is given to using coextrusion films which have a hard and scratch-resistant top layer and a softer base layer. Films of this kind can be used not only in a variety of plain colors but also for printed surfaces. A further possibility is to structure the surface by means of different embossing rolls during the extrusion of the film.

Furthermore, for the coating of fiber-cement slabs, it is possible more particularly to use the coextruded two-layer films described in WO-A 96/23823 and WO-A 97/46608. The two-layer films are composed of a base layer such as polystyrene or HIPS, for example, and a layer of adhesion promoter based, for example, on elastomeric styrene-butadiene block polymers. As already mentioned above, it is usually possible in these cases to do without an additional adhesive. The coextruded film is pressed onto the fiber slab in such a way that the layer of adhesion promoter comes into direct contact with the slab.

The films described in the above sections can be used not only in various plain colors but also for printed surfaces. Furthermore, the surface can be structured by different kinds of embossing rolls during the extrusion of the film.

Finally, the polymeric film may also function as a primer film, which permits simple aftertreatment such as coating, printing, with advertising slogans, for example, and so on.

Films such as the abovementioned ASA films, for example, can be subsequently altered in their color and shape by means of suitable aftertreatment such as coating, printing or embossing.

The films used have a thickness of between 50 and 750 μm, preferably between 100 and 500 μm, and most preferably between 200 and 350 μm. They can be produced from the corresponding starting materials in granule form by means of the known methods of film production, preference being given to the extrusion process for cast-film production.

In order to improve the adhesive properties it is possible for the films to have been subjected to a corona treatment on one or on two sides.

Methods suitable for producing the fiber-cement or concrete moldings are those described in the literature.

The fiber-cement slab for coating generally has a dimension ranging from approximately DIN A4 format up to several square meters. The thickness of the fiber-cement elements ranges typically from 6 to 25 mm. The slabs may be a number of meters in length.

The inventive coating decisively improves the breaking resistance and residual load-bearing capacity of the fiber-cement slab. This is achieved by the complete removal of air between slab and film, something which cannot be accomplished with conventional laminating methods (this is indeed possible in the case of flat elements).

Furthermore, the weather resistance and the tactility of the fiber-cement or concrete moldings can be decisively improved as a result of the polymeric film coating.

On the basis of their good weathering stability, the coated fiber-cement or concrete moldings can be used with advantage for exterior applications in the construction sector.

The moldings are more particularly suitable as facade elements, housings for solar collectors, noise barriers, flower boxes, roof tiles, roof battens, roof decks, balcony linings, etc. The surface modified by coating is easy to clean.

As a result of the coating with a polymeric film, the absorption of liquid by the fiber-cement or concrete molding can be almost completely eliminated.

By means of specific additions it is possible to minimize still further the growth of algae and moss and also the fungal infestation, which is in any case already less than with uncoated moldings.

Fiber-cement or concrete moldings are typically outstandingly suitable for producing park benches and garden furniture, for example. As already described, a corresponding polymeric film may give an appealing exterior.

### EXAMPLE 1

Double-sided coating of a fiber-cement slab with an ASA film

The substrate used for coating on two sides was a fiber-cement slab made of Pelicolor®, a commercially available, normally hardened fiber cement from Eternit AG. The slab was 120 cm long, 80 cm wide, and 8 mm high. In the first operation, the adhesive was applied to begin with. The adhesive used was an aqueous, polyurethane-based two-component system (consisting of binder and hardener) which was produced immediately prior to application by mixing the two individual components. In order to obtain a homogeneous mixture, the mixture was stirred at room temperature for at least 3 minutes using a KPG stirrer. The adhesive was then applied in a quantity of approximately 80 g/m² to both surfaces and to the 4 edges of the molding, using a Walther Pilot spray gun. The molding was then dried at room temperature for 20 minutes. In the next step, the fiber-cement slab was fixed by means of a holder at the two top ends (opposite side faces) and positioned in the middle of the coating capsule. The two polymeric films to be applied were in each case disposed between capsule wall and molding. This gave 3 chambers in the coating capsule: one chamber between the two polymeric films, in the middle of which the fiber-cement slab had been positioned (chamber A). The two other chambers were located in each case between polymeric film and capsule wall (chambers B, C). The polymeric films used were white-pigmented cast films of Luran® S, the ASA copolymer available commercially from BASF Aktiengesellschaft, which were 250 μm thick. Subsequently, all three separate chambers (A, B, C) in the capsule were evacuated simultaneously. On attainment of a vacuum of 25 mbar, the two polymeric films were heated to a temperature of 150° C. by means of IR lamps mounted on the capsule walls. When the temperature had been reached, heating was ended and chambers B and C were let down with air to atmospheric pressure, the vacuum in chamber A being maintained at the same time. The flooding of chambers B and C produced an overpressure by means of which the heated polymeric films were pressed onto the adhesive-sprayed surfaces and edges of the molding. At the level of the side faces, the two polymeric films met one another, and at this point a weld seam was formed, which sat on the side faces in the form of a frame around the entire molding. This was the end of the coating operation. The heating with the IR lamps during the operation had the further effect of activating the adhesive on the top faces and side faces of the molding, thereby producing very good adhesion between adhesive and polymeric film right after the end of the operation. When the coating procedure had been concluded, the coated molding was removed from the capsule. The projecting film continuing beyond the weld seam was removed by hand using a sharp blade.

1. A method of coating a fiber-cement or concrete molding, which comprises
a) placing and securing a molding in a capsule, a polymeric film being mounted between a capsule wall and the molding,
b) evacuating the air in the chamber between the polymeric film and the molding,
c) heating the polymeric film,
d) letting down a second chamber between the polymeric film and the capsule wall to atmospheric pressure with external air, and
e) thereby pressing the polymeric film onto the molding, and maintaining a vacuum during this pressing operation.

2. The method according to claim 1 for coating a molding on both sides, wherein the molding is brought between two polymeric films and in steps b) and e) a vacuum is applied and maintained in the chamber bordered by the two films, and, between the two polymeric films and the respective capsule wall, there are two further chambers which during step d) are let down to atmospheric pressure in order to press the films onto the opposite sides of the molding.

3. The method according to claim 1, wherein before step b) an adhesive is applied to the molding and/or to the polymeric films.

4. The method according to claim 1, wherein the films are primer films which can be easily aftertreated.

5. The method according to claim 1, wherein the film is composed of one or more polymers selected from the group consisting of polyvinyl chloride, styrene copolymers, polypropylene, polyvinylidene fluoride, thermoplastic polyurethane, and polymethyl methacrylate or is a coextrusion film comprising these materials, and has a layer thickness between 50-500 μm.

6. The method according to claim 5, wherein the film is an ASA film.

7. The method according to claim 1, wherein the molding is a fiber-cement slab.

8. The method according to claim 1, wherein the molding is made of concrete.

9. The method according to claim 1, wherein the molding is a roof tile, a roof batten or a roof covering.

10. The method according to claim 1, wherein the molding is a facade element.

11. The method according to claim 1, wherein the molding is a lining element.

12. The method according to claim 1, wherein the molding is a solar collector.

13. The method according to claim 1, wherein the molding is a road edging, a noise barrier or a balcony lining.

14. A single-sidedly coated molding obtainable according to the method of claim 1.

15. A double-sidedly coated molding obtainable according to any the method of claim 2.

16. The method according to claim 2, wherein before step b) an adhesive is applied to the molding and/or to the polymeric films

17. The method according to claim 2, wherein the films are primer films which can be easily aftertreated.

18. The method according to claim 3, wherein the films are primer films which can be easily aftertreated.

19. The method according to claim 2, wherein the film is composed of one or more polymers selected from the group consisting of polyvinyl chloride, styrene copolymers, polypropylene, polyvinylidene fluoride, thermoplastic polyurethane, and polymethyl methacrylate or is a coextrusion film comprising these materials, and has a layer thickness between 50-500 μm.

20. The method according to claim 3, wherein the film is composed of one or more polymers selected from the group consisting of polyvinyl chloride, styrene copolymers, polypropylene, polyvinylidene fluoride, thermoplastic polyurethane, and polymethyl methacrylate or is a coextrusion film comprising these materials, and has a layer thickness between 50-500 μm.
